(19) United States
(12) Patent Application Publication
(10) Pub. No.: US 2020/0001496 A1
(43) Pub. Date: Jan. 2, 2020

(54) SHIELDING DEVICE FOR A SAW, IN PARTICULAR A TABLE SAW, AND SAW EQUIPPED WITH SUCH A SHIELDING DEVICE, IN PARTICULAR A TABLE SAW

(71) Applicant: Scheppach Fabrikation von Holzbearbeitungsmaschinen GmbH, Ichenhausen (DE)

(72) Inventor: Markus Bindhammer, Friedberg (DE)

(73) Assignee: Scheppach Fabrikation von Holzbearbeitungsmaschinen GmbH, Ichenhausen (DE)

(21) Appl. No.: 16/488,277

(22) PCT Filed: Oct. 20, 2017
(86) PCT No.: PCT/EP2017/025313

§ 371 Date: Aug. 23, 2019

(30) Foreign Application Priority Data
Feb. 24, 2017 (EP) 17020067.9

(51) Int. Cl. B27G 19/02; B23D 59/00

(52) U.S. Cl. CPC B27G 19/02; B23D 59/003

(57) ABSTRACT

The invention is concerned with a shielding device (1) for shielding a saw blade (3) or band of a sawing machine against access by an operator and against ejection of workpiece parts, which can be attached to the sawing machine in such a way that, in a working position, it covers the saw blade (3) or band towards the operator. The shielding device (1) comprises a temperature monitoring unit (2) which has a temperature sensor (4).

The invention is characterized in that the temperature sensor (4) operates without contact and, with the shielding device (1) mounted on the sawing machine and located in the working position, is directed towards the toothing of the saw blade (3) or band, and a display device (5) displays the surface temperature detected by the temperature sensor (4) on the surface of the toothing of the saw blade (3), wherein the temperature monitoring unit (2) is formed as an autarkic operating unit and is mounted on the shielding device (1) such that it is detachable by an operator without tools.

The invention is further concerned with a sawing machine with such a shielding device (1).

The invention concerns a shielding device for shielding a saw blade of a saw, in particular of a circular table saw, according to the features of the preamble of claim 1, and a saw equipped with such a shielding device, in particular a circular table saw.

Such shielding devices are used to shield a saw blade or band, e.g. on circular table saws, trim saws and mitre saws, band saws etc. On circular table saws, for example, it is common to install, as a shielding device, a hood-shaped saw blade guard above the section of the saw blade protruding from the table.

Saw blades heat up during sawing due to friction. Overheating can only be recognised by circular burn marks or dents on the stationary saw blade. When overheated locally, the blade zones expand differently, the saw blade loses its tension, becomes wavy and flutters during sawing. Working with such overheated saw blades can cause life-threatening cracks.

In order to avoid accidents due to overheating of the saw blade, a machine tool monitoring device has therefore already been proposed, wherein the surface temperature of the saw blade is recorded by means of infrared sensors mounted on both sides of the saw blade and used as an input parameter for a tool control system which, for example, controls the speed of the saw blade accordingly, see, for example, German utility model DE 20 2013 007 344 U1.

Following the same principle, according to European patent application EP 2 596 891 A1, the saw blade is cooled with coolant in response to the output of an infrared temperature sensor located on the side of the saw blade. German patent application DE 198 30 605 A1 already describes a similar process.

As a further safety measure, saws of the generic type, in particular circular saws, generally have a saw blade guard, i.e. a hood-shaped cover which is placed over the saw blade when the circular saw is in operation and which shields the saw blade and thus protects a user of the saw from injuries caused by unintentional gripping into the rotating saw blade or by parts splintering off from the workpiece during machining.

In German patent application DE 10 2008 054 701 A1, it has already been proposed to attach sensor elements to the saw blade guard, among other things, in order to record a material parameter with these sensor elements that reflects whether a foreign body is present in a workpiece or not, so that the motor control can be switched off, for example in the case of a nail contained in a board. Among other things, this involves detecting the current tool temperature and, by changing it, detecting whether a foreign body is contained in the workpiece.

Furthermore, German patent application DE 10 2009 045 322 A1 shows the arrangement of radiation transmitters and receivers on the protective cover of the saw blade, which are directed towards a working area in front of the saw blade, with the aim of detecting whether there is a human limb there or whether regular operation of the saw can be carried out because there is only a workpiece, as intended.

CN 104 27 56 24 reveals a circular saw with a temperature sensor and a cooling water line attached to the saw blade guard, whereby the coolant supply is switched on or off in response to the detected temperature.

Starting from there, it is an object of the present invention to increase the safety of existing and new electrically operated saws by simple and cost-effective means and to provide incentives that these measures are also implemented in the area of low-cost do-it-yourself and hobby tools.

This object is solved with regard to a shielding device by the features of claim 1, with regard to a saw equipped with it by the features of claim 13.

According to the invention, the shielding device comprises a temperature monitoring unit with a temperature sensor which operates contactless or without contact and which, when the shielding device is fitted to the sawing machine and is in its working position, is directed towards or is pointing to the toothing of the saw blade or, in the case of a band saw for example, towards the saw band, and comprises a display device which displays the surface temperature on the surface of the toothing of the saw blade, detected by the temperature sensor. Further according to the invention, the temperature monitoring unit is formed as a self-sufficient or autarkic unit, i.e. it does not have to be connected to an external power supply or control and can be removed from the shielding device by the operator without tools, e.g. it can be pushed on or clipped on.

In accordance with the invention, a sawing machine with a saw blade or band is also proposed, to which a shielding device of this type is attached, covering the saw blade or band.

With the shielding device in accordance with the invention or with the sawing machine equipped with the shielding device in accordance with the invention, no largely automated safety solution is achieved as with the solutions known from the state of the art. However, especially on small and cost-effective sawing machines, which are used in the hobby and DIY sector, or on circular saws which have to be used under robust working conditions and therefore cannot be equipped with susceptible control electronics, the user is provided with an additional monitoring option which allows him to detect a sudden rise in temperature and thus an imminent failure of the saw blade or band and to counteract this with suitable measures, for example by switching off the saw or bringing the workpiece out of contact with the saw blade.

The self-sufficient temperature monitoring unit not only eliminates the need for corresponding power supply or control cables or radio links, but also makes it possible to offer saw blade protection hoods or the like as replacement parts for existing sawing machines which, in contrast to conventional saw blade or band screening devices, are equipped with such a temperature monitoring unit.

Even further in this direction, the temperature monitoring unit is detachably attached to the shielding device. This makes it conceivable, for example, to equip a whole set of sawing machines of a certain series with shielding devices that are equipped with corresponding holders for a temperature monitoring unit, so that a single temperature monitoring unit could be used on a plurality of shielding devices.

The fact that the temperature monitoring unit can be removed from the shielding device by the operator without tools gives the user an additional benefit. This is because the temperature monitoring unit provides a complete, non-contact surface thermometer that the user can then use independently of the sawing machine when the unit is removed.

For this utilization, it is particularly advantageous if the temperature monitoring unit further comprises a targeting aid device which emits, in the direction of detection of the temperature sensor, a light beam being point-shaped in cross section. The targeting aid device is then used to locate a measuring point whose surface temperature is to be measured with the temperature monitoring unit removed. For example, the targeting aid device can be formed as a laser diode with a convex lens that additionally bundles the laser beam.

Advantageous further developments are the subject of subclaims.

The proposed shielding device is particularly suitable for circular table saws and is therefore preferably formed as a saw blade guard that can be mounted above a table of a circular table saw.

Furthermore, the temperature monitoring unit of the shielding device is preferably operated by battery or accumulator, so that no supply lines for the power supply of the saw blade or band drive or control lines for their control are necessary. For this purpose, the temperature monitoring unit further preferably has a battery receiving compartment which is provided for receiving at least one battery or at least one accumulator cell and preferably has a removable cover for exchanging the battery or the accumulator.

Further advantageously, the temperature monitoring unit is equipped with an ON/OFF switch which can be used by an operator to switch it on or off, regardless of the operation of the saw itself.

Further advantageously, the temperature monitoring unit comprises a microcontroller wherein control routines for controlling the temperature monitoring unit are implemented so that, when the temperature monitoring unit is switched on, the detected surface temperature is displayed on the display device in response to the output of the temperature sensor. The microcontroller can also control optional auxiliary elements of the temperature monitoring unit, which will be discussed later.

The display device may be an OLED display, but other display devices such as an LED display or an LCD display may also be provided. A common infrared temperature sensor, which is now available at a reasonable price, is suitable as a temperature sensor.

The temperature monitoring unit receives an additional benefit if it comprises a cutting line display device, which can, for example, be in the form of a laser diode with refractive optics that projects a line pointing in the cutting direction onto the workpiece.

The shielding device may have a holder portion which can be fixedly attached to the sawing machine and a shield carrier portion which is movably accommodated thereon, so that the shielding device can be movably attached to the sawing machine, preferably pivotally movable, between an open position in which the saw blade is openly accessible or open, and the working position in which it covers the saw blade.

The surface of the toothing of the saw blade or band that is exposed to a particularly high load during use must be regarded as the surface of the saw blade or band that runs transversely to the cutting direction, in the case of a circular saw, i.e. the circumferential surface of the toothing of the saw blade that points in the radial direction. The temperature monitoring unit is therefore advantageously mounted on the shielding device in such a way that the temperature sensor is directed towards the surface running transversely to the cutting direction, in particular the circumferential surface of the toothing of the saw blade or band, if the shielding device is mounted on the sawing machine and is in the working position.

The shielding device of the proposed type is particularly suitable in its embodiment as a saw blade protection for a circular saw table. Accordingly, the sawing machine is advantageously formed as a circular table saw and accordingly has a machine table penetrated by a saw blade at a slot-shaped recess, which above the saw blade carries a shielding device formed as saw blade protection of the type described above.

In the following, a preferred embodiment of the invention is explained in more detail on the basis of the enclosed drawings.

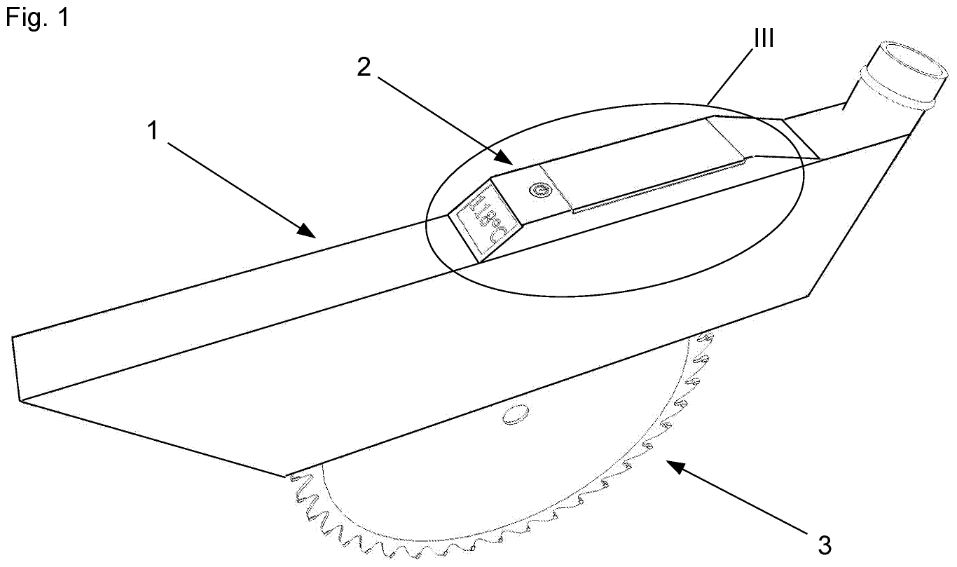

FIG. 1 shows a perspective view of an embodiment of the shielding device according to the invention in working position above a circular saw blade, formed as a saw blade guard for a circular saw;

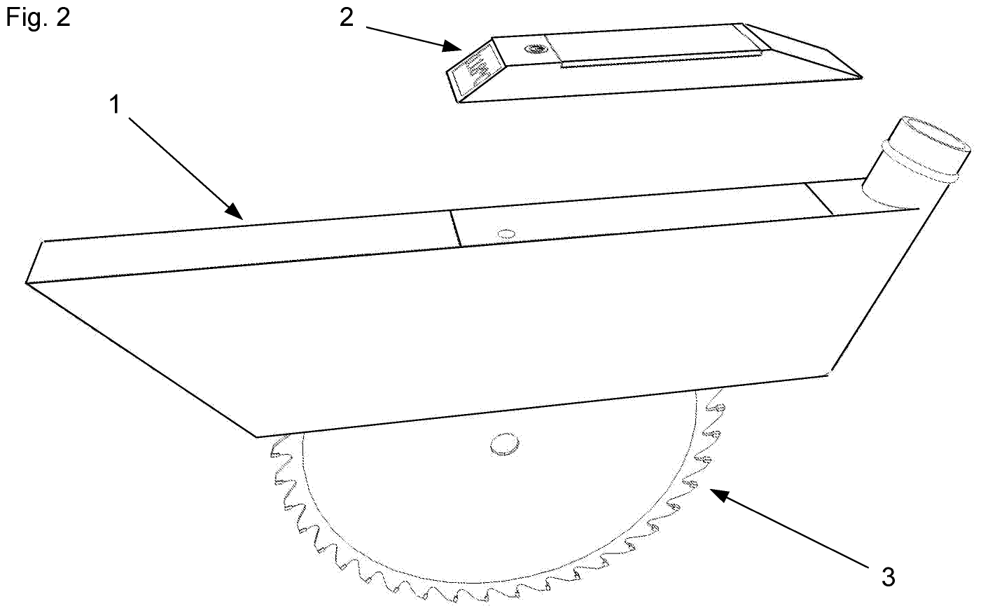

FIG. 2 shows a view corresponding to FIG. 1 with the temperature monitoring unit of the shielding device removed;

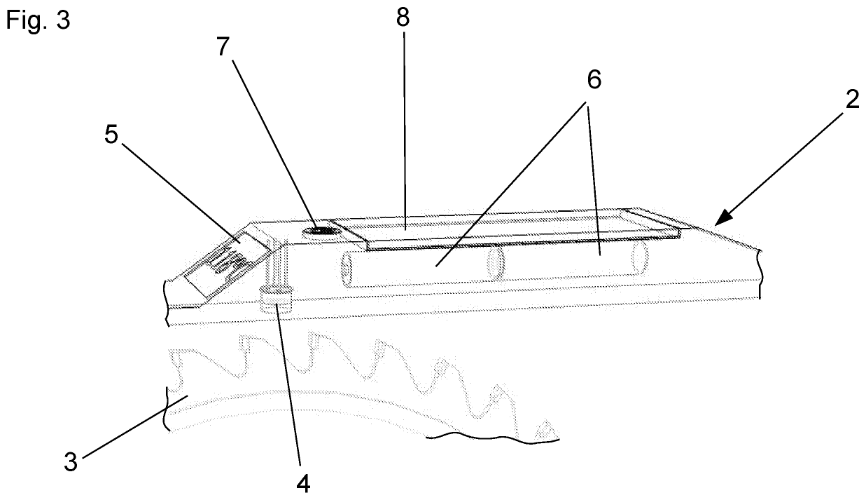

FIG. 3 shows detail III from FIG. 1 omitting the side walls of the shielding device;

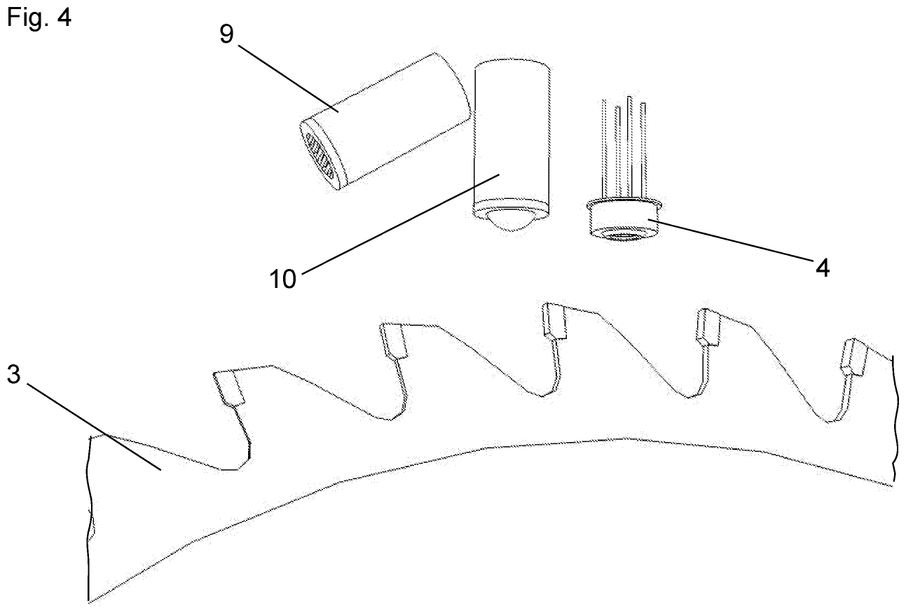

FIG. 4 shows a detail according to a variant of the embodiment of the invention shown in FIGS. 1 to 3; and

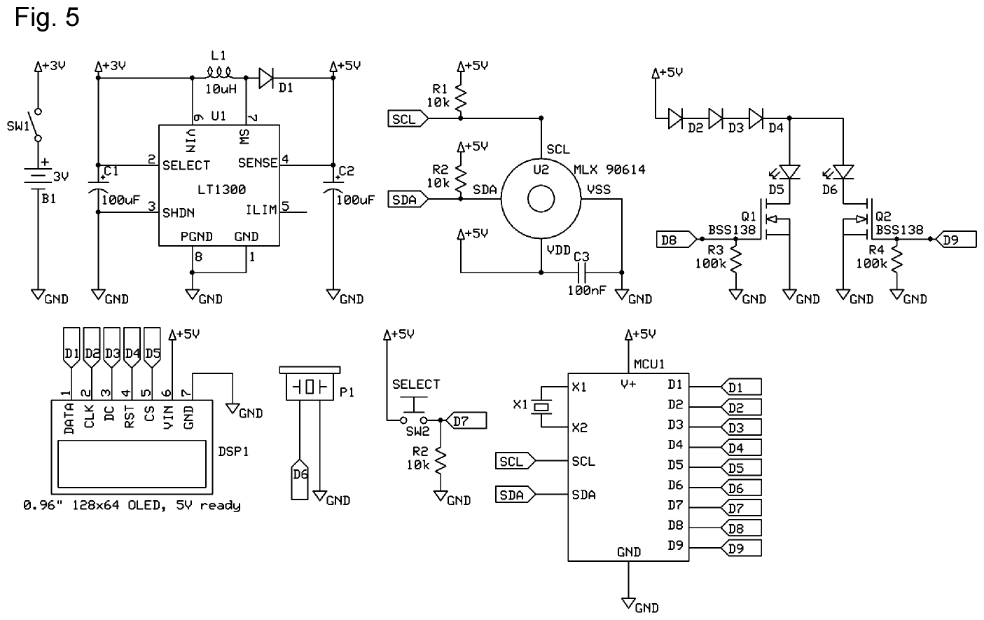

FIG. 5 shows an electrical circuit diagram of the temperature monitoring unit of the shielding device in the variant according to FIG. 4.

First, reference is made to FIG. 1, which shows a shielding device 1 in its working position above a saw blade 3 of a circular saw, which is designed as a saw blade guard or saw blade cover, and whose further details have been omitted here for reasons of clarity. The saw blade guard 1 has a roughly hood-shaped form and carries a temperature monitoring unit 2 on its upwardly directed end face, which, in principle, but without going closer into the technically known fasteners, is shown in FIG. 2.

FIG. 3 shows the details of temperature monitoring unit 2 of shielding device 1. One can see an infrared temperature sensor designated by reference sign 4, which is directed towards or which is pointing to the circumferential surface of the toothing of the saw blade 3 with an opening angle of 10° and which detects the temperature prevailing there. The measurement results obtained are processed in a non-displayed microcontroller unit and are displayed on a display device 5 formed as an OLED display, if the temperature monitoring unit 2 has been switched on at an ON/OFF switch button 7. The energy required to operate the temperature monitoring unit 2 is supplied by two AAA battery cells 6 inserted in a battery compartment. The battery compartment is accessible via a removable cover 8. The temperature monitoring unit 2 thus operates completely independently and can also, as FIG. 2 shows, be removed from the shielding device 1 and used as an independent surface thermometer. In addition to the temperature of a remote object, the sensor can also measure the ambient temperature.

FIG. 4 shows a further development of the temperature monitoring unit 2 shown in FIGS. 1 to 3 with two additional laser diodes 9, 10 above the saw blade 3 in position adjacent to the IR temperature sensor 4, but omitting all other components. The laser diode 9 points in the cutting direction and is equipped with refractive optics so that it projects a line pointing in the cutting direction onto the workpiece section in front of the saw blade 3 and thus functions as a cutting line display. The laser diode 10, on the other hand, serves as a bearing aid if the user wants to use the removed temperature monitoring unit 2 as an independent IR thermometer and points in the same direction as the IR temperature sensor 4. To bundle the laser beam of the laser diode 10, it can be equipped with a convex lens.

FIG. 5 shows the electronics of the temperature monitoring unit further developed according to FIG. 4, wherein partially deviating reference characters have been used for the individual elements in the circuit diagram context.

The sensor transmits the measurement result via I2C bus to the microcontroller MCU1. The entire electronic circuit is powered by two AAA batteries B1 to keep the dimensions small. The circuit is put into operation via the on/off switch SW1. The step-up DC-DC converter U1 converts the voltage of 3 V, provided by the two AAA batteries B1 connected in series, into regulated 5 V, which is required for the temperature sensor U1 and the microcontroller MCU1. The converter U1 requires only four external components: the two electrolytic capacitors C1 and C2 as well as the choke L1 and the diode D1. The I2C bus has two pull-up resistors R1 and R2. The C3 ceramic capacitor is used for decoupling.

D5 and D6 are laser diodes. The threshold voltage of the series-connected diodes D2, D3 and D4 provides a voltage drop of approx. 2.1 V, so that a supply voltage of approx. 2.9 V is given for the two laser diodes D5 and D6. The logic-level-N-channel MOSFETs Q1 and Q2 pull the cathodes of the laser diodes D5 and D6 to ground when 5 V is applied to their gates. The laser diode D5 has a convex lens so that a point-shaped laser beam emerges. The laser diode D6 has a refractive optics, so that a linear laser beam emerges. The laser diode D5 serves as a targeting aid in order to target an object whose temperature is to be determined when the temperature monitoring unit is removed from the saw blade guard 1 and serves as an IR thermometer. The laser diode D6 serves as a cutting line display when the temperature monitoring unit is located on the saw blade guard 1 and the temperature of the saw blade 3 is to be determined.

In order to ensure good legibility even over a greater distance and in the case of poor lighting conditions, the OLED display DSP1 is used. Data between the OLED display DSP1 and the microcontroller MCU1 are transmitted via SPI or also via the I2C bus. The SW2 button can be used to select various functions. These include at least switching from line laser operation to point laser operation and vice versa, displaying the ambient and saw blade temperature in ° C. and ° F. with acoustic warning by the piezo transducer P1 and optical warning by corresponding warning texts or warning symbols on the OLED DSP1 in case of overheating of the saw blade, a timer indicating on the OLED DSP1 the time, which has elapsed since the circuit has been set into operation, further the display of the average ambient and saw blade temperature in ° C. and ° F., which is calculated from the stored measured values of the temperature sensor and the elapsed time since the circuit has been set into operation, as well as a display on the OLED DSP1 on the state of charge of the batteries B1 and the rotation of the displayed text or symbols by 180°.

The B1 batteries are accessible for replacement via the battery cover 1. The OLED DSP1 is mounted on the saw blade guard at an angle clearly readable for the user of the machine during operation. The SW1 on/off switch or SW2 button is located in front of the battery cover 1. The temperature sensor U2 is located on the underside of unit A and points to tooth 3 of the saw blade 4 via a recess in the saw blade guard 2.

Deviations and modifications from the embodiments shown are possible without leaving the scope of the invention.

1. A shielding device (1) for shielding a saw blade (3) or band of a sawing machine against access by an operator and against ejection of workpiece parts, which can be attached to the sawing machine in such a way that, in a working position, it covers the saw blade (3) or band towards the operator, the shielding device (1) comprising a temperature monitoring unit (2) which has a temperature sensor (4), wherein
the temperature sensor (4) operates without contact and, with the shielding device (1) mounted on the sawing machine and located in the working position, is directed towards the toothing of the saw blade (3) or band, and a display device (5) displays the surface temperature detected by the temperature sensor (4) on the surface of the toothing of the saw blade (3), wherein
the temperature monitoring unit (2) is formed as an autarkic operating unit and is mounted on the shielding device (1) such that it is detachable by an operator without tools.

2. The shielding device (1) according to claim 1, wherein the shielding device (1) is formed as a saw blade guard (1) mountable above a table of a circular table saw.

3. The shielding device (1) according to claim 1, wherein the temperature monitoring unit (2) is battery or accumulator-operated and comprises a battery compartment, which is preferably accessible via a removable cover (8), for accommodating batteries (6) or accumulators.

4. The shielding device (1) according to claim 3, wherein the temperature monitoring unit (2) has an ON/OFF switch at which it can be switched ON or OFF by an operator.

5. The shielding device (1) according claim 4, wherein the temperature monitoring unit (2) comprises a microcontroller wherein control routines for controlling the temperature monitoring unit (2) are implemented so that, when the temperature monitoring unit (2) is switched on, the detected surface temperature is displayed on the display device (5) in response to the output of the temperature sensor (4).

6. The shielding device (1) according to claim 1, wherein the display device (5) is formed as an OLED display.

7. The shielding device (1) according to claim 6, wherein the temperature sensor (4) is formed as an infrared temperature sensor (4).

8. The shielding device (1) according claim 1, wherein the temperature monitoring unit (2) has a cutting line display device (9) which is formed in particular as a laser diode (9) with refractive optics projecting a line pointing in the cutting direction onto the workpiece.

9. The shielding device (1) according to claim 2, wherein the temperature monitoring unit (2) is pushed or clipped onto the shielding device (1).

10. The shielding device (1) according to claim 8, wherein the temperature monitoring unit (2) comprises a targeting aid device (10) which emits, in the direction of detection of the temperature sensor, a light beam which is point-shaped in cross-section, for targeting a measuring point whose surface temperature is to be measured with the removed temperature monitoring unit (2), in particular a targeting aid device (10) in the form of a laser diode (10) with a convex lens.

11. The shielding device (1) according to claim 2, wherein the shielding device (1) has a holder section able to be fixedly attached to the sawing machine and a shield carrier section which is movably accommodated thereon, in particular pivotably, so that the shielding device (1) can be attached to the sawing machine movably, in particular pivotably, between an open position in which the saw blade (3) lies open and the working position covering the saw blade (3).

12. The shielding device (1) according to claim 11, wherein the temperature sensor (4) is directed, with the shielding device (1) mounted on the sawing machine and located in the working position, towards that surface of the toothing of the saw blade (3) or band that is running transversely to the cutting direction, in particular on the circumferential side of the saw blade (3).

13. A sawing machine having a saw blade (3) or band to which a shielding device (1) covering the saw blade (3) or band is attached for shielding the saw blade (3) or band against access to and ejection of workpiece parts, wherein the shielding device (1) is formed according to one of the preceding claims.

14. The sawing machine according to claim 13, wherein the sawing machine is constructed as a circular table saw with a machine table penetrated by a saw blade (3) at a slot-shaped recess, to which machine table a shielding device (1) formed as saw blade guard (1) is attached above the saw blade (3), the shielding device (1) attached to the sawing machine in such a way that, in a working position, it covers the saw blade (3) or band towards the operator, the shielding device (1) comprising a temperature monitoring unit (2) which has a temperature sensor (4) wherein
the temperature sensor (4) operates without contact and, with the shielding device (1) mounted on the sawing machine and located in the working position, is directed towards the toothing of the saw blade (3) or band, and a display device (5) displays the surface temperature detected by the temperature sensor (4) on the surface of the toothing of the saw blade (3), wherein
the temperature monitoring unit (2) is formed as an autarkic operating unit and is mounted on the shielding device (1) such that it is detachable by an operator without tools.
